(19) United States
(12) Patent Application Publication
(10) Pub. No.: US 2006/0218070 A1
(43) Pub. Date: Sep. 28, 2006

(54) Method of advertising, marketing and auctioning real estate

(76) Inventor: William W. Lange, Newport Beach, CA (US)

Correspondence Address: EDWIN TARVER, 16830 Ventura Blvd., SUITE 360, Encino, CA, 91436, US

(21) Appl. No.: 11/088,059

(22) Filed: Mar. 23, 2005

(51) Int. Cl. G06Q 40/00

(52) U.S. Cl. 705/37

(57) ABSTRACT

A method of advertising, marketing, and auction sale of real estate properties and more particularly a method of handling last minute online bidding extensions are described. An Internet website has been designed for this purpose such that prospective customers or interested bidders may view property specific photographs and other details with respect to the property on property profile pages. In the electronic bidding format, as long as at least one bid is made within an established bid period before the deadline, the bidding can be extended for a pre-determined amount of time.

### CROSS-REFERENCE TO RELATED APPLICATION

None

### FEDERALLY SPONSORED RESEARCH

Not Applicable

### SEQUENCE LISTING OR PROGRAM

Not Applicable

### BACKGROUND

The present invention relates to a method of advertising, marketing and auctioning real estate properties, and more particularly to a method of handling last minute online bidding extensions.

The auction process is both a well-established and tested method of conducting business. Today, auctions have become one of the most popular methods of marketing and selling goods and services. Various buyers and sellers have utilized numerous variations on how auctions are conducted. These various auctioning techniques, including in-person, closed, English, increasing and the like, are typically tailored to suit the requirements of both buyers and sellers.

In order to sell real estate by auction, bidders typically had to be physically present. This puts geographically distant bidders at a disadvantage. Various methods have been suggested and are used in which auctions are held over the Internet to overcome this disadvantage.

Problems associated with real estate bidding and auction methods known in the prior art have left room for improvement however. One problem associated with Internet or “on-line” auctioning is premature bidding closure. In an in-person auction, bidding activity tends to increase as the scheduled bidding deadline approaches. Generally, it is possible to achieve a better auction price if the auction is allowed to continue as long as bids continue to come in. Typically, this goal can be achieved using an “overtime,” wherein the closing time for a specific lot is automatically extended based on the rate of bids continuing to flow into the auction. Overtimes discourage bidders from submitting last minute bids in an attempt to overcome a competitive reaction from other bidders.

An example of supplier side bidding overtime can be found in U.S. Pat. Nos. 6,216,114, 6,223,167, and 6,499,018 to Alaia et al. These patents disclose an auctioning method with flexible overtime periods. These inventions are designed to stop online bidding in the event of a computer or other problem, hold the auction in “pending” status, and then increase the length of the auction by the corresponding amount of time in a multiple seller reverse-bidding type of auction.

U.S. Pat. App. No. 20040039680 to Markus et al. describes a reverse electronic auctioning method wherein sellers bid to a single buyer. This patent discloses a type of auction wherein bidders are notified of a remaining time interval when the remaining auction time is less than, or equal to the remaining time interval. An extension can then be carried out for the comparison of bids. Although Markus and the Alaia patents disclose an overtime concept, they are different from the embodiment of the present invention.

In the present invention, overtime functions are automatically accomplished. When an online auction bid is submitted within a previously disclosed time period prior to the established bid deadline, the bid deadline is extended for a like time period. This object of the invention can be colloquially referred to as called “Last Call.”

It is a principle object of the present invention to provide a method of advertising, marketing, and auctioning real estate properties, wherein said auctioning can be conducted in sealed or live electronic bid formats. Another object of the invention is to provide a method of advertising, marketing, and auctioning real estate properties to provide a method of handling last minute online bidding extensions.

A further object of the invention is to provide an Internet web site dedicated to advertising, marketing, and auctioning real estate property wherein interested bidders may log in, view and download specific property information such as photographs, maps, government reports, tax information, and plot plans. They may then obtain property specific financing information by viewing a web page dedicated to each individual property, wherein such property profile pages contain all the information necessary for an interested party to become familiar with the property and to place a sealed or electronic, online bid to purchase the property.

A further object of the invention is to provide a password protected area on the web site, called private auction events, where potential bidders may only view the above described property information and place property bids by invitation of the seller or the seller's agent.

### SUMMARY

The present invention relates to a method of advertising, marketing, and auctioning real estate properties and more particularly to a method of handling last minute online bidding extensions.

An Internet website is used as an auction forum dedicated to advertising, marketing, and auctioning real estate, and contains details on properties for sale in the United States and throughout the world. Real estate owners may post a property for sale on the site. The site then advertises individual properties for sale in a wide variety of media. Individual media outlets are each assigned an individual media code.

Each advertisement contains a unique uniform resource locator address (URL), which specifies the particular property for sale, and the media code associated with that advertisement. By typing in the Internet address contained in an advertisement, a potential bidder is directed to a property profile page on the auction website. In addition, the auction website records the media code associated with the advertisement.

The website then generates a media tracking report to gauge the efficacy of a particular advertisement against others. The website can then attach a cost per response valuation to every type of advertising in an auction marketing campaign. Advertisements that are inexpensive and generate a large number of potential bidders can be preferred over advertisements that generate little interest. In addition, a cost per respondent value can be tracked through the auction process.

When an auction begins, interested bidders may view photographs and download specific information about the property including maps, government reports, tax information, plot plans and financing information. This information may be obtained by viewing a property profile web page dedicated to each individual property (property profile page). Each property profile page contains a specific bidding deadline when all the bidding for that specific property shall cease.

The auctioning method of the present invention can be conducted in sealed or live electronic bidding formats. Regardless of the bidding format, a bid deadline is used to stop bidding at the end of an auction. No bids are accepted after the published bid deadline. However, in the electronic format, if a bid is submitted during a pre-defined period before the bidding deadline, the deadline is extended for another pre-defined period. This extension of time is designated a “last call.” The new bid deadline will continue to be extended in this manner until no new valid bids are received within the predefined time period before the bid deadline. When no more bids have been submitted in a “last call” period, the bidding is closed and the property in question awarded to the highest qualified bidder.

### BRIEF DESCRIPTION OF THE FIGURES

FIG. 1 is an illustration of a web page of current auction events, displaying a multitude of auction properties. Potential bidders selecting a group of properties or an individual property are directed to a property portfolio page if the event contains more than one property or to a property profile page if the event contains a single property.

FIG. 2 is an illustration of a web page displaying a portfolio of current auction events grouped around a single seller or other common feature. Potential bidders selecting an individual property from this portfolio page are directed to its property profile page.

FIG. 3 is an illustration of a property profile page where a property is being auctioned in a sealed bid format wherein the details of a property for sale are disclosed without revealing any bidder identity, bid amount or bid history.

FIG. 4 is an illustration of a property profile page where a property is being auctioned in an online format wherein the details of a property for sale and bidder identities, bid amounts and the bid history are disclosed.

### DESCRIPTION

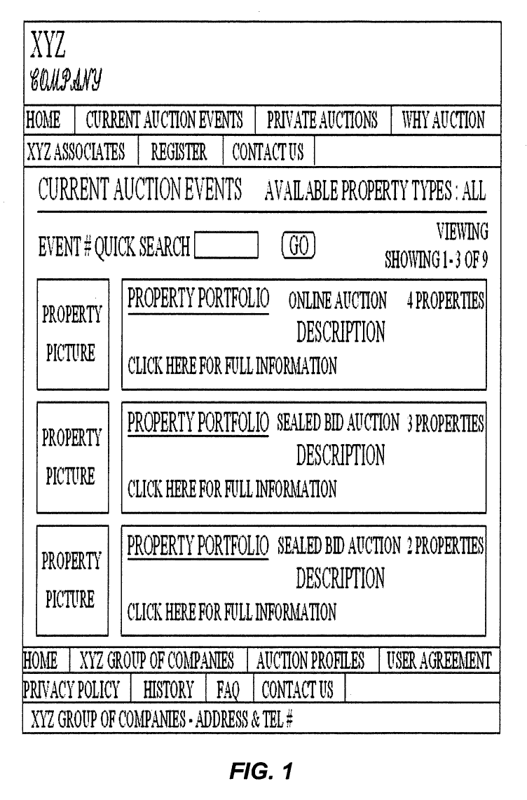

The embodiments of the present invention are illustrated by way of demonstration web pages as shown in FIGS. 1 through 4.

FIG. 1 shows a web page displaying brief descriptions of current auction events. An auction event may include multiple properties or it may include a single property.

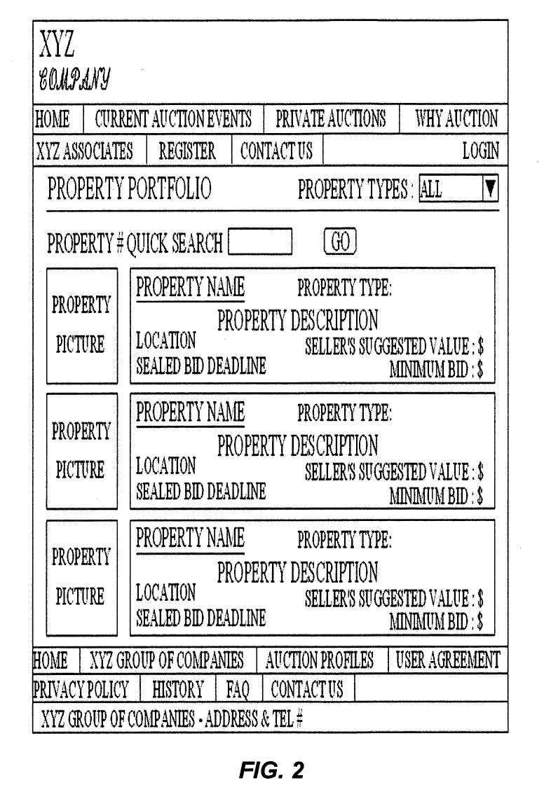

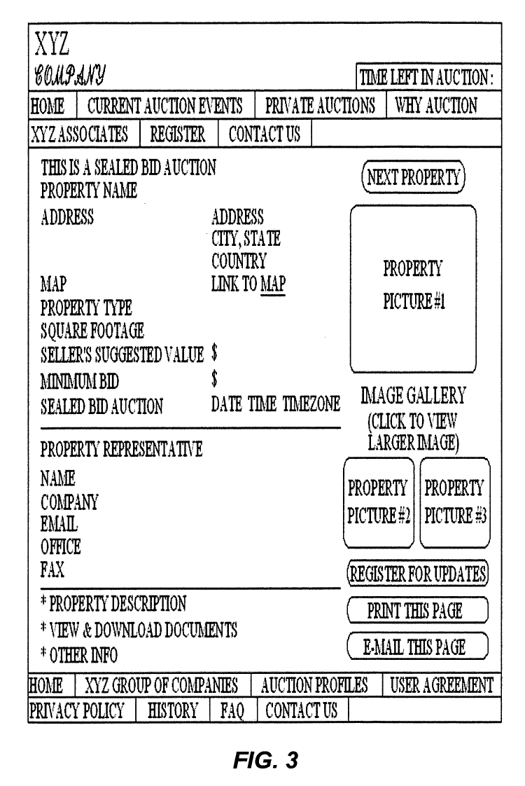

If an auction event includes multiple properties, a description of the various properties including their general locations, property types and sizes and various other information is displayed. A single picture of one of the properties is also displayed. By clicking on the picture or the general property description, the potential bidder is taken to the property portfolio page described in FIG. 2. If the auction event includes a single property, a description of that property including its picture, location, size and various other information is displayed. By clicking on the picture or the property description, the potential bidder is taken directly to the property profile page as described in FIGS. 3 & 4.

The current auction events page also includes a search tool which allows potential bidders to find a specific property or groups of properties of interest by using various filters such as location, type, size and value. From the current auction events page, a potential bidder can navigate to any of the sealed bid or online auctions on the web site.

FIG. 2 illustrates a portfolio of properties associated with a single seller or other common feature. This is known as the property portfolio page. When multiple properties are owned by a single entity, or have another similar common features, it is appropriate to group them in a portfolio subcategory since potential buyers may have an interest in properties according to their common features. The property portfolio page also includes a search tool which allows potential bidders to find specific properties of interest by using various filters such as location, type and price. By selecting an individual property from the portfolio page, prospective bidders are directed to its property profile page.

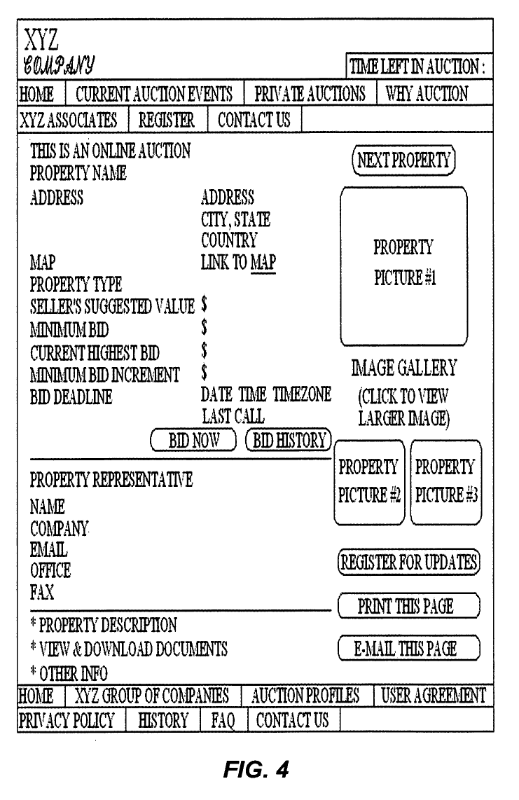

FIGS. 3 and 4 show individual properties on a part of the website known as a “property profile page.” Each property has its own unique property profile page. Property profile pages disclose a particular real estate property slated for auction and information regarding the property. Interested bidders may view photographs and download information on a particular property including maps, government reports, tax information, plot plans and obtain financing information by viewing the particular property profile page. Interested bidders who have not registered under the website are requested to register by completing a brief data sheet. Once they have registered, they may log-in with a specific username and password and view or download documents related to the property in question. Other information, such as the minimum bid increment, bid deadline, contact information of the property representative who is responsible for conducting tours and viewing of that specific property, and other detailed information on the property can be found on individual property profile pages.

Property portfolio and property profile pages can also be accessed directly from the URL address listed in various print and electronic advertisements. When a property or group of properties is advertised for sale, the advertisement contains a URL that will direct an interested party directly to a property portfolio page in the event multiple properties are being advertised and to a property profile page in the event a single property is being advertised. Information is imbedded in the URL regarding the auction property and the media that published the advertisement. The website assimilates information regarding the number of times a particular URL is accessed or “hit” and generates a media tracking report.

The media tracking report compares the price of an advertisement with the number of “hits” resulting from that advertisement. It also records information about bidders that have signed in from a particular advertisement; whether they are principles or brokers. In this manner, the website is able to assign a cost per respondent value to individual media. In the case where respondents register on the website, the cost per respondent value can then be analyzed through the several stages of the auction process.

For instance: If an advertisement costs $6000 and receives 600 responses, each response is valued at $10. If 60 of the 600 responses register on the website, each registration is valued at $100. If 6 of the 60 registrations, bid on a property, each bid is valued at $1000, and if 1 of those six is the winning bidder, they are valued at $6000. By employing this method, the website can quickly determine the cost effectiveness of a particular advertisement, and can amend future media schedules in response.

In order to submit an initial sealed bid or place a subsequent online electronic bid, interested bidders must first register on the website. A written or a sealed bid must be submitted to the seller's agent on or before the bid deadline by utilizing the approved bid form, which can be downloaded from the property profile page. The completed bid form can then be sent or delivered to the seller's agent. Additionally, the bid must be at or above the amount established by the seller as the lowest allowable bid (minimum bid) as set forth on the property profile page.

When submitting the bid form, interested bidders must include a bid deposit in the form of a deposit payment. For example, a bid deposit might be the highest of $30,000, or two percent (2%) of the amount of the bid. A winning bidder's deposit is credited toward the purchase price of the property. For all unsuccessful bidders, the bid deposit is returned in full within a designated period from the time a winning bidder is determined.

The seller retains the right to change the auction format from a sealed bid auction to a live online electronic auction at any time. A sealed bid auction format can be seen in FIG. 3. During a sealed bid format, the details of a property for sale are disclosed without revealing any bidder identity, bid amounts or bid history. Upon declaring an online auction, all interested bidders or parties are allowed to view the amount of the highest sealed bid by means of a bid history update located on the property profile page. Once the bidding format has moved from sealed bid to online bid, potential bidders who have not previously submitted a bid may still do so provided they submit their initial bid on a bid form and submit it to the seller's agent along with the required bid deposit.

Each time a new electronic bid is placed during an online auction, the bidder's identity, the amount of the bid, and the date and time that the bid was received by the website is published in the bid history section. All bidders and other interested parties are encouraged to frequently review the bid history during the online auction in order to receive updates on the highest bid. No additional bid deposit is required when placing subsequent bids during an online auction.

Upon declaring an online auction, electronic bids may be tendered up to the bid deadline using a bid button on the property profile page. Bids may be tendered up to the bid deadline subject to a possible Last Call extension as described below. If no bid is submitted within the designated period of time (usually, but not limited to 24 hours) prior to the published bid deadline, the bidding will be closed. It should be noted that access to the bid history section is only available from the property profile page after an online auction has been declared.

If an online auction bid is submitted within a pre-determined time before the published bid deadline, the deadline will be extended for another pre-determined period of time, which will be referred to as “Last Call.” In the event another new bid is received before the new bid deadline, the deadline will again be extended for an additional pre-determined period. The new bid deadline will continue to be extended in this manner until no new valid bid is received prior to the bid deadline. When no new valid bid is received, the bidding will be closed.

For Example, if a published online auction bid deadline is initially set for Apr. 22, 2005 at 17:00, and a new bid is submitted on Apr. 22, 2005 at 11:02, then the new bid deadline will be extended to Apr. 23, 2005 at 17:00, assuming that the designated time period is 24 hours. Further, if another new bid is received on Apr. 23, 2005 at 16:34, the bid deadline will once again be extended to Apr. 24, 2005 at 17:00. The new bid deadline will continue to be extended in this manner until no new bid is received within the designated period of time (e.g., 24 hours) of the bid deadline. Bidding will only be closed when no new bids are received within 24 hours of the bid deadline.

If a potential bidder has not previously submitted a bid on a property subject to a Last Call, an initial bid may still be made on the property. However, this initial bid must be delivered on a bid form along with a proper bid deposit. Each time a new bid is submitted during the Last Call, the bidder's identity, the amount of the bid, and the date and time that the bid was submitted is published in the bid history. All bidders and potential bidders will be advised to review the bid history frequently during the Last Call. It should be noted that no additional bid deposit is required when placing a bid during the Last Call.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An internet website for the auctioning of real property wherein;
(a) the website includes a private, password protected, auction events section and a public auction events section;
(b) real property or properties for auction are listed by sellers and posted on a property profile page, containing the specified bid deadline for that particular property, photographs maps, government reports, tax information, plot plans and financing information;
(c) interested bidders register by completing a brief data sheet and log-in with a specific username and password, view or download documents related to the property in question, including information such as current highest bid, minimum bid increment, contact information of the property representative who is responsible for conducting tours and viewing of that specific property, and other detailed information on the property;
(d) the website retaining and processing media codes when prospective bidders access the website through an advertised URL, and the website generating cost per respondent information, including the number of hits, the percentage of total hits, the cost per hit, the total registrations broken down between principles and brokers, and the ultimate cost per registration for each individual advertisement in real time as auction events progress;
(e) the website organizing individual auctions according to a hierarchy of auctions grouped into property portfolios, and those portfolios grouped into all current auctions;
(f) the website having a search capability for prospective bidders;
(g) the website having a bid deadline extension feature enabling the auctioneer to extend a deadline based on bidder activity and the proximity of a bid to the bid deadline; and
(h) the website enabling the auctioneer to control the visibility of bidder information, including bidder identity, bid amount, and the date and time a particular bid was made.

2. A method for conducting a real estate auction via a communications network such as an Internet website comprising the steps of;
(a) a property seller or agent accessing a property auction website using a secure user identification and password;
(b) the property seller or agent uploading specific real estate property sales information regarding a property for sale to the website;
(c) the website, at the direction of the property seller or agent making said listing information available to prospective bidders;
(d) the website receiving bids comprising sealed and electronic formats until a designated bid deadline;
(e) the website determining if a bid deadline extension event occurs; and
(f) the website determining the highest bid received; and awarding the property to the highest bidder.

3. The method of claim 2, wherein the website contains multiple real estate property profiles on an auction index page.

4. The method of claim 3, wherein individual property profiles contain information about individual real estate properties, comprising photographs, maps, government reports, tax information, plot plans, title reports, environmental reports, financing and other information related to real estate sales.

5. The method of claim 2, wherein the website contains multiple auction web pages, wherein each auction web page comprises a single auction for a property.

6. The method of claim 5, wherein auction web pages contain information about individual real estate properties comprising photographs, maps, government reports, tax information, plot plans, title reports, environmental reports, financing and other information related to real estate sales.

7. The method of claim 2, wherein the bids are received in a format comprising written or sealed bids, maintained under secrecy until the bid deadline, and unsealed thereafter.

8. The method of claim 2, wherein the bid format may be changed from the sealed bid auction format to a real-time electronic bidding format at the discretion of said website.

9. The method of claim 8, wherein the electronic bidding format contains a bidder identity, bid history, amount and time submitted and place a bid.

10. The method of claim 2, wherein the time duration of an auction can be extended by a pre-determined period of time prior to said deadline.

11. The method of claim 10, wherein the time duration can be an indeterminate amount of time as determined by the auctioneer at the time of the auction.

12. The method of claim 9, wherein said extension is triggered if said bid is submitted within said pre-determined previously disclosed period of time prior to said published bid deadline.

13. The method of claim 2, wherein said website emails information regarding said auctions to said members.

14. The method of claim 13, wherein said information comprises highest bid information, bid deadline information, and other information relevant to said auction.

15. The method of claim 2, wherein private, password protected auctions are provided for exclusive high-end properties.

16. The method of claim 15, wherein the private auctions can only be accessed by password protected invitation by the seller or the seller's agent.
